(19) United States
(12) Patent Application Publication
(10) Pub. No.: US 2023/0406070 A1
(43) Pub. Date: Dec. 21, 2023

(54) THERMAL MANAGEMENT SYSTEM, METHOD OF CONTROLLING SAME, AND HEATER

(71) Applicant: LITENS AUTOMOTIVE PARTNERSHIP, Woodbridge (CA)

(72) Inventors: Zheng X. ZHENG, Markham (CA); Eric VANDENBERG, Kleinberg (CA); Evan HURRY, Holland Landing (CA); Julian PIRES, Etobicoke (CA); Andrew Malcolm BOYES, Aurora (CA)

(21) Appl. No.: 18/250,079

(22) PCT Filed: Oct. 26, 2021
(86) PCT No.: PCT/CA2021/051511

§ 371 Date: Apr. 21, 2023

Related U.S. Application Data
(60) Provisional application No. 63/198,540, filed on Oct. 26, 2020.
(60) Provisional application No. 63/199,782, filed on Jan. 25, 2021.

(51) Int. Cl. B60H 1/22; F28D 20/00; B60L 58/26; B60K 11/02; B60L 58/27; B60L 53/16

(52) U.S. Cl. CPC B60H 1/2221; B60H 1/2218; F28D 20/00; B60L 58/26; B60K 11/02; B60L 58/27; B60L 53/16; B60H 1/04

(57) ABSTRACT

In an aspect, a heater module is provided for a heater for a thermal management system for an EV. The module includes a housing having an inlet and an outlet, a module inlet header in fluid communication with the inlet so as to receive a coolant from the inlet, a module outlet header that is in fluid communication with the outlet so as to transport the coolant to the module outlet, a plurality of module coolant conduits extending between the module inlet header and the outlet header, wherein there is a PCM storage space defined in the housing between the module coolant conduits, thermal conductors extending from the plurality of module coolant conduits into the PCM storage space, and a quantity of phase-change material in the PCM storage space and in contact with the plurality of thermal conductors. The housing is positioned in engagement with an electric heating element.

### CROSS-REFERENCE TO RELATED APPLICATIONS

This application claims the benefit of U.S. Provisional Application 63/198,540, filed Oct. 26, 2020, and 63/199,782, filed Jan. 25, 2021, the contents of both of which are incorporated herein by reference in their entirety.

### FIELD OF THE DISCLOSURE

This disclosure relates generally to vehicles that employ an electric motor to drive at least one of the wheels of the vehicle, and more particularly to systems and methods that help the thermal management systems of such vehicles to extend their range.

### BACKGROUND

Electric vehicles (which includes any vehicle the employs an electric motor to drive at least one of the wheels of the vehicle) are typically limited in their range, and so there is a focus on improving the range of such vehicles. An example of a technology that is applied with the intent of improving range, is regenerative braking. Regenerative braking takes what would normally be wasted frictional energy and uses this energy to charge the battery pack of the vehicle.

A situation where some energy that could otherwise be recovered is not, occurs when such a vehicle is driven in cold weather, and has a battery pack that is cold. In such a situation, if regenerative braking were to occur, the battery management system of the vehicle would prevent the battery pack from receiving any charge, since charging a battery pack, particularly with a surge of power, while the battery is cold, could damage the battery pack. Accordingly, in such situations, the energy that is taken out of the vehicle's forward motion is simply lost to friction.

It would therefore be advantage to provide additional ways to improve the range of electric vehicles.

### SUMMARY

In an aspect, a heater module is provided for a heater for a thermal management system for an electric vehicle. The heater module includes a module housing having a module inlet and a module outlet, a module inlet header that is in fluid communication with the module inlet so as to receive a coolant from the module inlet, a module outlet header that is in fluid communication with the module outlet so as to transport the coolant to the module outlet, a plurality of module coolant conduits extending between the module inlet header and the outlet header, wherein there is a PCM storage space defined in the module housing between the module coolant conduits, a plurality of thermal conductors extending from the plurality of module coolant conduits into the PCM storage space, and a quantity of phase-change material in the PCM storage space and in contact with the plurality of thermal conductors. The heater module housing is positioned in engagement with an electric heating element.

In another aspect, a heater for a thermal management system for an electric vehicle is provided and includes a heater housing having a heater inlet and a heater outlet, a plurality of heater modules contained in the heater housing. Each of the plurality of heater modules includes a module housing having a module inlet and a module outlet, a module inlet header that is in fluid communication with the module inlet so as to receive a coolant from the module inlet, a module outlet header that is in fluid communication with the module outlet so as to transport the coolant to the module outlet, a plurality of module coolant conduits extending between the module inlet header and the outlet header, wherein there is a PCM storage space defined in the module housing between the module coolant conduits, a plurality of thermal conductors extending from the plurality of module coolant conduits into the PCM storage space; and a quantity of phase-change material in the PCM storage space and in contact with the plurality of thermal conductors, and at least one electric heating element, wherein the module housing of each of the plurality of heater modules has at least one of the at least one electric heating element positioned adjacent thereto for transmission of heat into the phase-change material.

In another aspect, a thermal management system is provided for an electric vehicle, the electric vehicle including a traction motor, a traction motor battery, and a charger for use in charging the traction motor battery from an external charge source, the thermal management system comprising a vehicle coolant conduit system that contains a coolant; a pump that is positioned to drive the coolant to flow through the vehicle coolant conduit to draw heat from the charger during operation of the charger; and a heater that includes a heater housing having a heater inlet and a heater outlet, wherein the heater inlet and the heater outlet are fluidically connected to the vehicle coolant conduit system; a heater coolant conduit system that fluidically connects the heater inlet and the heater outlet, wherein there is a PCM storage space defined in the heater housing outside the heater coolant conduit system; a quantity of phase-change material in the PCM storage space, positioned to undergo heat exchange with the coolant in the heater coolant conduit system; and at least one electric heating element positioned to heat the phase-change material; the thermal management system further includes a controller programmed to operate the charger to charge the traction motor battery when the electric vehicle is connected to an external power source, wherein the controller is programmed to operate the pump to drive the coolant to flow through the vehicle coolant conduit to draw heat from the charger during operation of the charger, thereby heating the coolant, wherein, during operation of the charger, the controller is programmed to determine a temperature of the coolant, and to drive coolant flow through the heater in order to heat the phase-change material if the temperature of the coolant is higher than a selected threshold coolant temperature, and wherein, when the electric vehicle is connected to the external power source, the controller is programmed to operate the at least one electric heating element in order to heat the phase-change material at least some of the time.

In another aspect, a method for controlling a thermal management system for an electric vehicle when the electric vehicle is connected to an external power source is provided. The electric vehicle includes a traction motor, a traction motor battery, a charger for use in charging the traction motor battery from the external charge source, and a heater including a heater housing, a heater coolant conduit system, and a quantity of phase-change material, wherein the heater housing has a heater inlet and a heater outlet, wherein the heater inlet and the heater outlet are fluidically connected to the vehicle coolant conduit system, wherein the heater coolant conduit system fluidically connects the heater inlet and the heater outlet, wherein there is a PCM storage space defined in the heater housing outside the heater coolant conduit system, wherein the volume of phase-change material is in the PCM storage space, positioned to undergo heat exchange with a coolant in the heater coolant conduit system. The method includes:
a) determining whether the traction motor battery is at a selected battery temperature at which the traction motor battery can accept a charge;
b) if the traction motor battery is not at the selected battery temperature, heating the traction motor battery, and when the traction motor battery is at at least the selected battery temperature, charging the traction motor battery using the charger;
c) driving coolant flow through the traction motor battery and the charger to draw heat from the traction motor battery and the charger into the coolant;
d) determining a temperature of the coolant and determining whether the temperature of the coolant is higher than a selected threshold coolant temperature; and
e) driving coolant flow through the heater after steps c) and d) to heat the phase-change material.

### BRIEF DESCRIPTION OF THE DRAWINGS

The foregoing and other aspects of the invention will be better appreciated with reference to the attached drawings, wherein:

FIG. 1 is a schematic view of a thermal management system for an electric vehicle, in accordance with an embodiment of the present disclosure;

FIG. 1A is a side elevation view of an electric vehicle having the thermal management system shown in FIG. 1;

FIG. 2 is a perspective view of a heater that is part of the tms shown in FIG. 1;

FIG. 3 is a perspective partially-exploded view of the heater shown in FIG. 2;

FIG. 4 is a perspective view of a subassembly that is part of the heater shown in FIG. 3;

FIG. 5 is a perspective exploded view of the subassembly shown in FIG. 4, which includes a plurality of heater modules;

FIG. 6 is a perspective exploded view of one of the heater modules shown in FIG. 5; and

FIG. 7 is a side view of part of the subassembly shown in FIG. 4

FIG. 8 is a flow diagram illustrating a method of controlling the thermal management system.

FIG. 9 is a perspective view of another heater in accordance with the present disclosure.

FIG. 10 is an exploded view of the heater shown in FIG. 9.

FIG. 11 is a sectional view of the heater shown in FIG. 9.

### DETAILED DESCRIPTION OF EXAMPLE EMBODIMENTS

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

The indefinite article “a” is not intended to be limited to mean “one” of an element. It is intended to mean “one or more” of an element, where applicable, (i.e. unless in the context it would be obvious that only one of the element would be suitable).

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. In particular, the term “server” is not indicative of a single processing unit but may encompass a cluster or cloud service that comprises multiple physical or virtual processing units, memories, databases, and/or storage devices. Any method, application or module herein described may be implemented using computer readable/executable instructions that may be stored or otherwise held by such computer readable media and executed by the one or more processors.

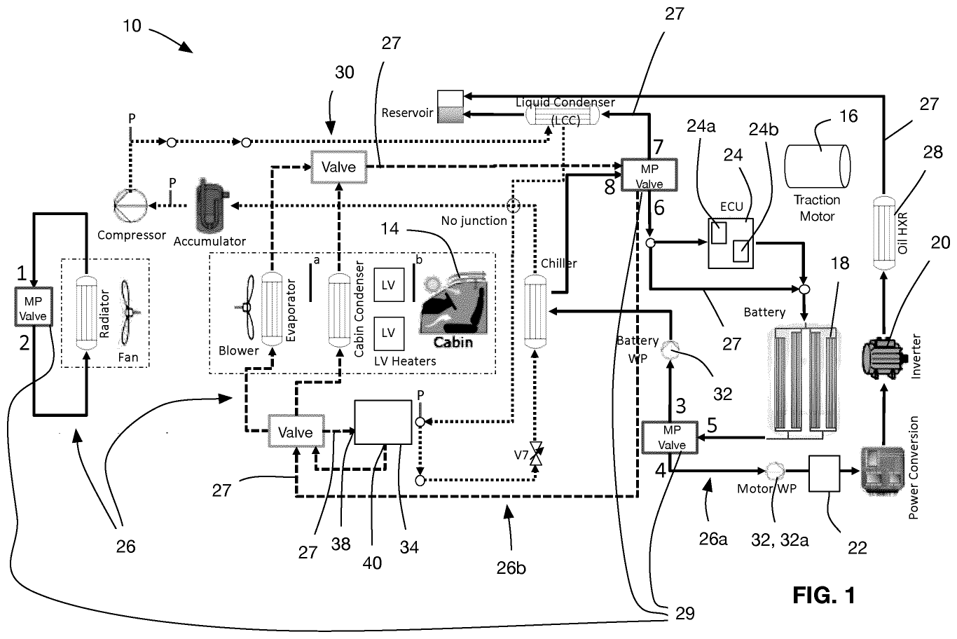

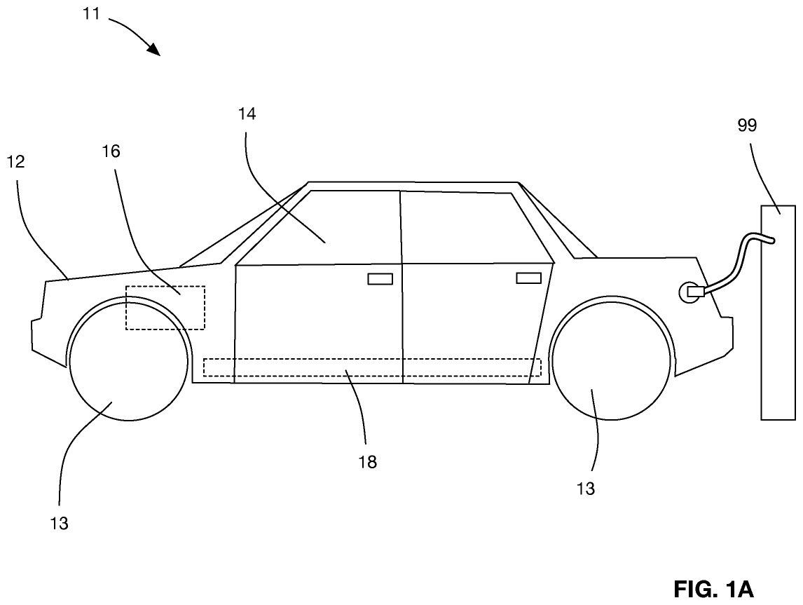

FIG. 1 shows a schematic representation of a thermal management system 10 for an electric vehicle shown at 11 in FIG. 1A. With reference to both FIGS. 1 and 1A, apart from the thermal management system the electric vehicle 11 includes, among other things, a vehicle body 12 including a passenger cabin 14 for holding vehicle occupants, a plurality of wheels 13, a traction motor 16 for driving the plurality of wheels 13, a traction motor battery 18 and an inverter 20 for providing power to the traction motor 16, a charger 22 for use in charge the traction motor battery 18, and a controller 24 for controlling operation of various elements of the electric vehicle 11.

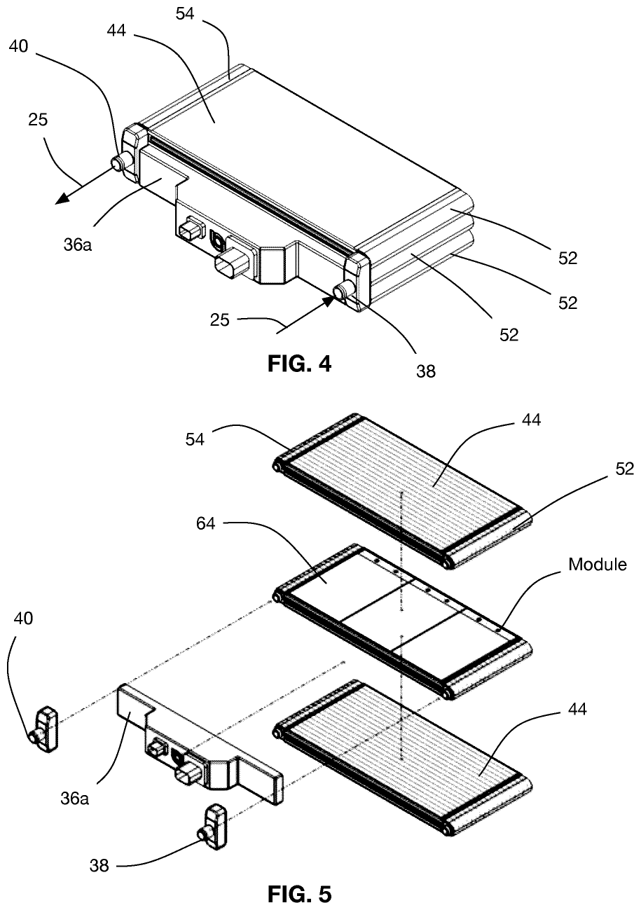

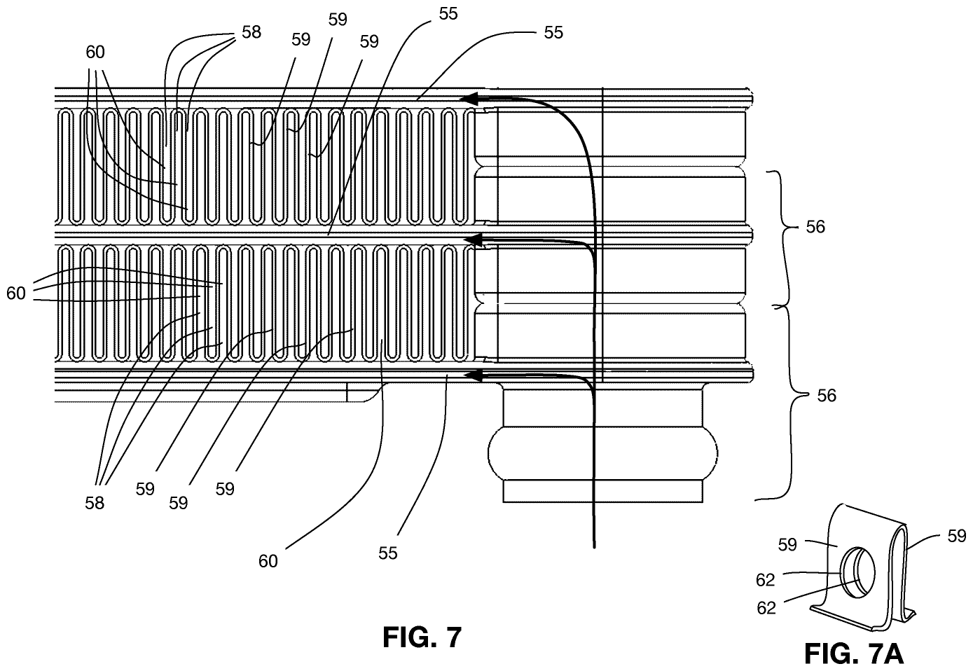

The thermal management system 10 includes, among other things, a vehicle coolant conduit system 26, which includes a plurality of fluid conduits 27 and which contains a coolant 25 (represented by arrows in FIGS. 4 and 7), and which is used for, among other things, cooling the traction motor 16, heating the passenger cabin 14, cooling and/or heating the traction motor battery 18, cooling the inverter 20, cooling the charger 22, and cooling and/or heating other elements of the electric vehicle 11. In the embodiment shown, the traction motor 16 may have its own dedicated oil cooling system, wherein oil flows through the traction motor 16 and then through an oil-to-coolant heat exchanger shown at 28.

In the example embodiment shown, the vehicle coolant conduit system 26 is illustrated as having two portions, namely a vehicle systems portion 26a and a cabin portion 26b, however, the coolant in these two portions 26a and 26b is the same coolant, as these two portions 26a and 26b are fluidically connected to one another via a multi-port valve 29. The multi-port valve 29 in the example embodiment shown has eight ports, and is used to direct coolant throughout the vehicle coolant conduit system 26. The thermal management system 10 may further include a refrigerant conduit system 30 that is used for cooling the passenger cabin 14.

One or more pumps 32 may be included in the thermal management system 10 for driving coolant to flow through the vehicle coolant conduit system 26. A pump shown at 32a in particular is used for driving coolant to flow through the charger 22 to draw heat from the charger 22 during operation of the charger 22 (e.g. when the electric vehicle 11 is connected to an external power source shown at 99 (such as a charging station at the home of the owner of the electric vehicle 11), and the charger 22 is being used to charge the traction motor battery 18 from the external power source 99).

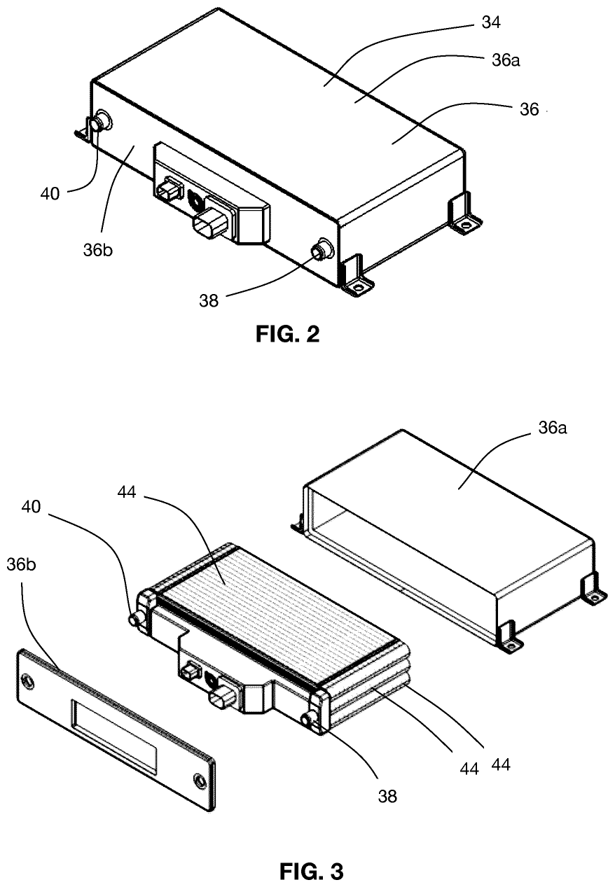

The thermal management system 10 further includes a heater shown at 34. Referring to FIGS. 2 and 3, the heater 34 includes a heater housing 36 having a heater inlet 38 and a heater outlet 40. In the example shown, the heater housing 36 includes a main heater housing portion 36a and a cover plate portion 36b connected to the main heater housing portion 36a in any suitable way, however any other suitable number of components may make up the heater housing 36. The heater inlet 38 and the heater outlet 40 are fluidically connected to the vehicle coolant conduit system 26 (FIG. 1).

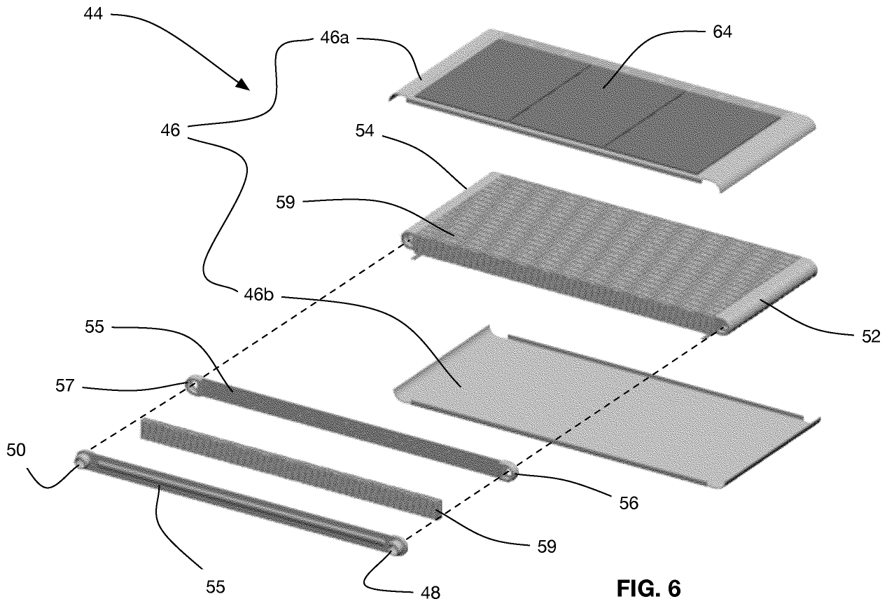

The heater 34 further includes a heater coolant conduit system (FIG. 5) that fluidically connects the heater inlet 38 and the heater outlet 40. The heater coolant conduit system is described in further detail below, in relation to the example embodiment of the heater 34 shown in more detail in FIGS. 3-7. In the embodiment shown, the heater 34 includes a plurality of heater modules 44 which are contained in the heater housing 36. Three heater modules 44 are shown as being contained in the heater housing 36. However, it will be understood that there could be any other suitable number of heater modules 44 in the heater housing, such as two heater modules 44 or four or more heater modules 44, or even one heater module 44.

As shown in FIGS. 5, 6 and 7, each heater module 44 includes a module housing 46 that may be formed from a plurality of housing portions including a first housing portion 46a and a second housing portion 46b, having a module inlet 48 and a module outlet 50, which are in fluid communication with the heater inlet 38 and the heater outlet 40, respectively. The heater module 44 further includes a module inlet header 52 that is in fluid communication with the module inlet 48 so as to receive coolant from the module inlet 48. The heater module 44 further includes a module outlet header 54 that is in fluid communication with the module outlet 50 so as to transport coolant to the module outlet 50. The heater module 44 further includes a plurality of module coolant conduits 55 that extend between the module inlet header 52 and the module outlet header 54. The module coolant conduits 55, and the module inlet and outlet headers 52 and 54 together may make up the heater coolant conduit system.

Each module coolant conduit 55 may be a separately formed member that includes a module inlet header segment 56 and a module outlet header segment 57. The separately formed members are placed adjacent one another such that the module inlet header segment 56 and the module outlet header segment 57 of each one of the separately formed members mates with the module inlet header segment 56 and the module outlet header segment 57, respectively, of the adjacent separately formed member. There is a space 58 defined in the module housing 46 between the module coolant conduits 55. This space 58 may also therefore be said to be defined in the heater housing 36 outside the heater coolant conduit system.

In the embodiment shown, a fin arrangement that includes a plurality of fins 59 extending from the plurality of module coolant conduits 55 into the space 58. The plurality of fins 59 may be formed in any suitable way. For example, the plurality of fins 59 may be in the form of an undulating pattern. The plurality of fins 59, in the form of an undulating pattern may therefore be contiguous with one another, as shown in FIG. 7. For each module coolant conduit 55, the plurality of fins 59 may be welded or otherwise joined at one extremum of the undulating pattern, to that module coolant conduit 55, and may optionally engage or be joined to, at their other extremum to the adjacent module coolant conduit 55.

A quantity of phase-change material 60 (also referred to as PCM 60) is positioned in the space 58, in order to undergo heat exchange with the coolant in the heater coolant conduit system. The space 58 may therefore be referred to as a PCM storage space 58. The phase-change material 60 is used to store energy in the form of thermal energy (heat), which can be released to the coolant in the vehicle coolant conduit system 26 at suitable times, in order to heat a thermal load in the electric vehicle 11, such as, for example, the passenger cabin 14 and/or the traction motor battery 18. Thus, the stored heat can be used to reduce the need to consume battery power in order to heat a thermal load in the electric vehicle 11.

The use of the stored heat in the phase-change material 60 is particularly advantageous in cold weather conditions, where the temperature of the traction motor battery 18 may prevent the traction motor battery 18 from taking a charge quickly enough during a regenerative braking event. Accordingly, in a conventional electric vehicle, the kinetic energy from a braking event would be lost. However, the heater 34 described herein, in at least some embodiments, is able to convert that energy into electrical energy to heat the heating element, which in turn is converted to heat, which is stored in the phase-change material 60, for later use in transferring to the coolant, in order to heat a thermal load, as noted above.

The phase-change material 60 may be any suitable known phase-change material known in the vehicle manufacture industry. The temperature at which the phase-change material 60 changes phase (referred to as the transition temperature), may be any suitable temperature such as in the range of between about 10 degrees C. up to 80 degrees C. Alternatively, the transition temperature may even be outside this range.

The fins 59 are positioned in the space 58 and help to conduct heat from the coolant in the module coolant conduits 55 to the phase-change material and from the phase-change material 60 to the module coolant conduits 55. In other words, the fins 59 transfer heat between the module coolant conduits 55 and the phase-change material 60. The fins 59 may be made from any suitably thermally conductive material such as a metal, such as, for example, aluminum or steel.

Optionally, through-holes 62 (FIG. 7A) may be provided in the plurality of fins 59. These through-holes 62 permit an increased amount of phase-change material 60 to be contained in the space 58, so as to help increase the amount of thermal energy storage that the heater 34 is capable of. The through-holes 62 extend parallel to the module coolant conduits 55 (i.e. in the direction of the progression of fins 59 along the module coolant conduits 55).

The heater 34 includes at least one electric heating element 64 positioned to heat the phase-change material 60. In the embodiment shown, the at least one electric heating element 64 is in the form of a plate that is in contact with the module housing 46, optionally via a thermal gel to enhance heat transfer therebetween.

The electric heating element 64 may use any suitable voltage, such as, for example somewhere in the range of between 60 V or even less in some embodiments, up to as high as hundreds of volts, or even higher, depending on the particular application. In a particular example, about 250 V may be used.

The electric heating element 64 is used to electrically heat the phase-change material 60 in any of several situations. For example, in embodiments in which the electric vehicle 11 includes a regenerative braking system that drives a generator during braking events, it is possible that the electric heating element 64 may be operated using electrical current generated from the generator during a regenerative braking event. In some embodiments the electric vehicle 11 may be configured to operate the electric heating element 64 when the electric vehicle 11 is connected to (e.g. plugged in to) the external power source 99.

It will be noted that the module housing 46 of each of the plurality of heater modules 44 has at least one electric heating element 64 positioned adjacent thereto for transmission of heat into the phase-change material 60.

The heater 34 in the embodiment shown includes three heater modules 44 and two electric heating elements 64 (i.e. a first electric heating element 64 between a first heater module 44 and a second heater module 44, and a second electric heating element 64 between a second heater module 44 and a third heater module 44).

The controller 24 may be an ECU (Electronic Control Unit) that is configured to control the operation of the thermal management system 10 and the heater 34 in particular. The controller 24 includes a processor 24a and a memory 24b (FIG. 1). The memory 24b stores data and code. The processor 24a executes the code and uses the data as needed during execution of the code, to control the operation of the thermal management system 10. The controller 24 may be programmed to operate the charger 22 to charge the traction motor battery 18 when the electric vehicle 11 is plugged in to the external power source 99.

In some embodiments, the controller 24 is programmed to operate the pump 32a to drive the coolant to flow through the vehicle coolant conduit system 26 to draw heat from the charger 22 during operation of the charger 22 (i.e. during charging of the traction motor battery 18 when the electric vehicle 11 is connected to the external power source 99), thereby heating the coolant in the vehicle coolant conduit system 26. During operation of the charger 22, the controller 24 may be programmed to determine a temperature of the coolant, and to drive coolant flow through the heater 34 in order to heat the phase-change material 60 if the temperature of the coolant is higher than a selected threshold coolant temperature. The controller 24 may determine the temperature of the coolant in any suitable way, such as by means of an indirect sensing structure that senses the temperature of a metallic element through which the coolant flows, or by means of a direct sensing structure that is positioned right in the coolant flow. The selected threshold coolant temperature is a temperature that is sufficiently high that would permit the coolant to heat the phase-change material 60. Thus, the selected threshold coolant temperature may be a certain number of degrees higher than a temperature of the phase-change material 60. The controller 24 may, therefore, also need to determine the temperature of the phase-change material 60 in order to determine whether the coolant is at a temperature that is higher than the selected threshold coolant temperature.

When the electric vehicle 11 is plugged in to the external power source 99, the controller 24 is programmed to operate the at least one electric heating element 64 in order to heat the phase-change material 60 at least some of the time. For example, in some embodiments, the controller 24 may operate the electric heating element 64 only when the temperature of the coolant is below the selected threshold coolant temperature. In other embodiments, the controller 24 may operate the electric heating element 64 at all times when the electric vehicle 11 is plugged in to the external power source 99.

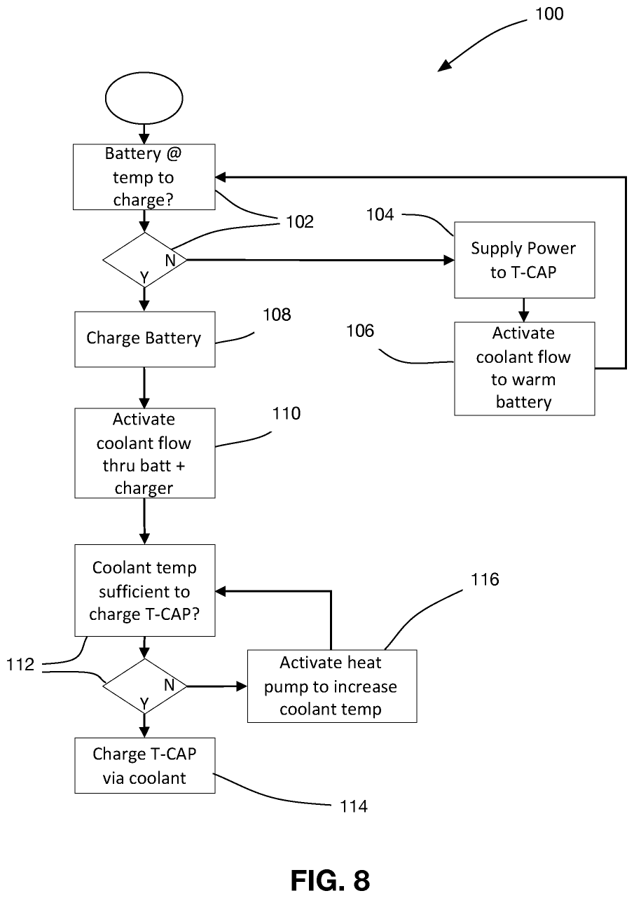

FIG. 8 is a flow diagram illustrating a method 100 of controlling elements of the thermal management system 10 while the electric vehicle 11 is connected to the external power source 99. The method 100 includes a step 102 where it is determined whether the traction motor battery 18 is at a temperature at which it can accept a charge. If the traction motor battery 18 is not at a temperature at which it can accept a charge, the traction motor battery 18 is heated. For example, in the embodiment shown, electrical power may be supplied to the heater 34 in order to heat the phase-change material 60 and the coolant therein at step 104, and at step 106, coolant flow is driven through the traction motor battery 18 in order to heat the traction motor battery 18. If the traction motor battery 18 is at a temperature at which it can accept a charge, the traction motor battery 18 is charged using electrical power from the external power source 99 at step 108. During charging of the traction motor battery 18, the charger 22 and the traction motor battery 18 will heat up. Thus, if the controller 24 deems it beneficial, coolant flow may be driven through the traction motor battery 18 and the charger 22 at step 110 in order to keep their respective temperatures below respective threshold temperatures. At step 112, the controller 24 determines whether the temperature of the coolant is higher than the selected threshold coolant temperature described elsewhere in the present application (i.e. determines whether the coolant is at a temperature that is sufficiently high to heat the phase-change material 60). If so, then then at step 114, the coolant flow is driven through the heater 34 in order to heat the phase-change material 60. If the temperature of the coolant is not higher than the selected threshold coolant temperature, then at step 116 the controller may activate a heat pump to increase the temperature of the coolant.

Based on the above, the method 100 may be said to include:
a) determining whether the traction motor battery is at a selected battery temperature at which the traction motor battery can accept a charge (i.e. step 102);
b) if the traction motor battery is not at the selected battery temperature, heating the traction motor battery, and when the traction motor battery is at least the selected battery temperature, charging the traction motor battery using the charger (i.e. steps 104, 106 and 108);
c) driving coolant flow through the traction motor battery and the charger to draw heat from the traction motor battery and the charger into the coolant (step 110);
d) determining a temperature of the coolant and determining whether the temperature of the coolant is higher than a selected threshold coolant temperature (step 112); and
e) driving coolant flow through the heater after steps c) and d) to heat the phase-change material (step 114).

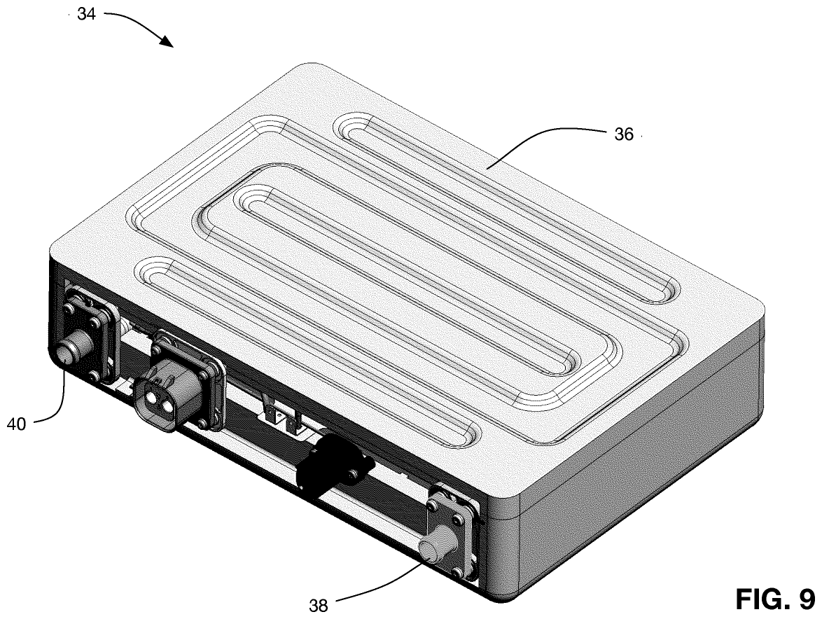

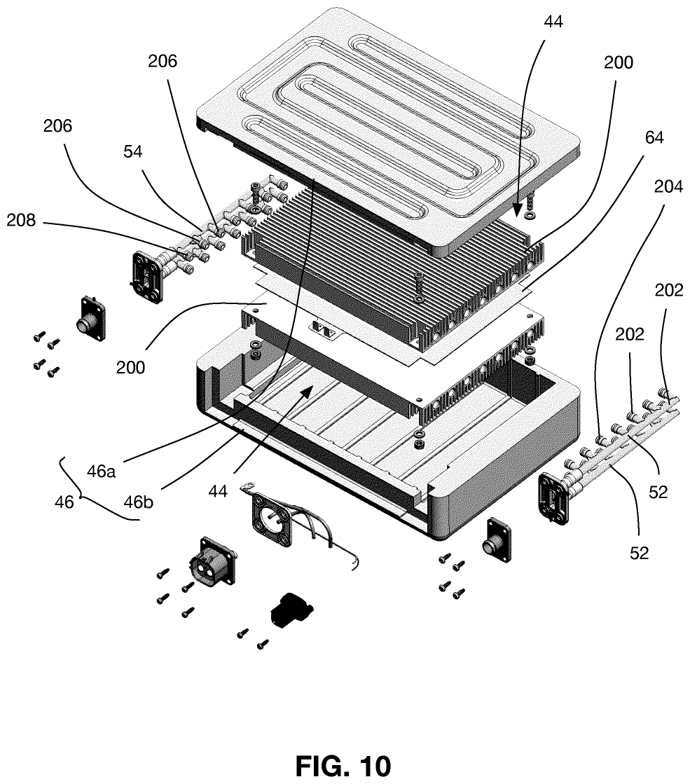

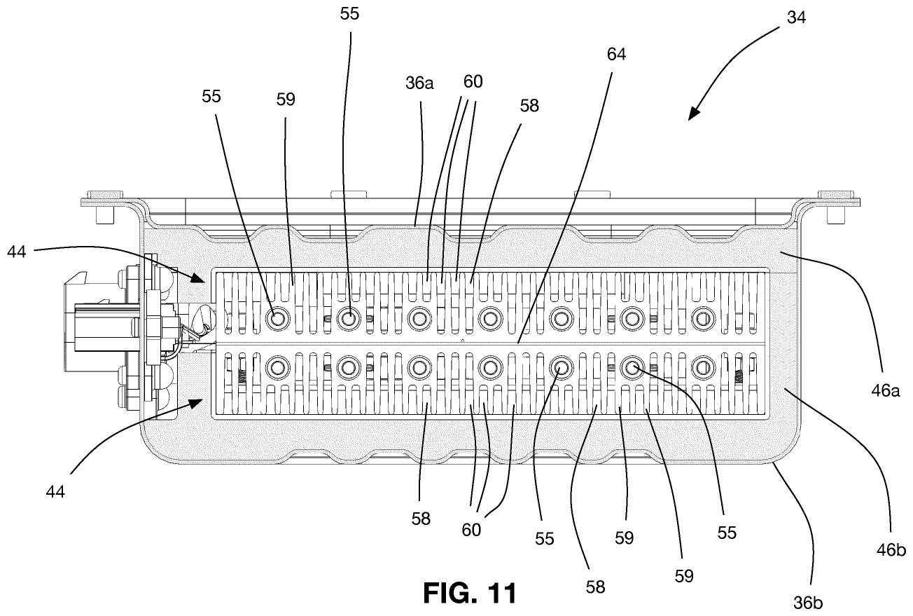

FIGS. 9, 10 and 11 illustrate another embodiment of the heater 34. The heater 34 may be similar to the heater 34 shown in FIGS. 2-7. Differences are described below. The embodiment shown in FIGS. 9-11 has only two heater modules 44, however, it will be understood that more modules could be provided, such as, for example four heater modules 44. The module housing 46 shown in FIGS. 9-11 enclose two modules 44 instead of each module 44 having a dedicated housing. The fins 59 in the embodiment shown in FIGS. 9-11 are formed monolithically with the module coolant conduits 55 in a combined conduit/fin element, shown at 200. By contrast, the fins 59 in FIGS. 2-7 are formed by an undulating strip of material that is joined (e.g. welded) to the module coolant conduits 55, and is therefore integral with the module coolant conduits 55, but is not monolithic with them, since they are originally separate members that are joined to the module coolant conduits 55.

As can be seen, the fins 59 in FIGS. 9-11 extend in the same direction as the module coolant conduits 55. As a result, it would be straightforward to mold or cast the combined conduit/fin element 200, since the mold plates that form the features could be pulled apart in the same direction that the fins 59 and the module coolant conduits 55 extend. Because of the monolithic construction of the combined conduit/fin element 200, a greater amount of heat transfer can take place between the module coolant conduits 55 and the fins 59. Molding or casting the combined conduit/fin elements 200 reduces the overall amount of time required to manufacture the heater 34.

As in the embodiment shown in FIGS. 2-7, the PCM 60 is stored in the PCM storage space 58, which, like in the embodiment shown in FIGS. 2-7, is the space present between the fins 59.

In the embodiment shown in FIGS. 9-11, there is a module inlet header 52 and the module outlet header 54 which are not each made from a plurality of segments joined together with seals, but are instead formed as single integral elements. The module inlet header 52 includes a plurality of inlet conduit stubs 202 with seals 204, which sealingly connect to the module coolant conduits 55. Similarly the module outlet header 54 includes a plurality of outlet conduit stubs 206 with seals 208, which sealingly connect to the module coolant conduits 55.

It will be understood that the fins 59 in the embodiments shown in FIGS. 2-7 and 9-11 are but examples of thermal conductors. Any other suitable type of thermal conductor could be used to facilitate heat transfer between the PCM 60 and the coolant 25. For example, the thermal conductors could be cylindrical spikes that extend away from the module coolant conduits 55.

While the description contained herein constitutes a plurality of embodiments of the present invention, it will be appreciated that the present invention is susceptible to further modification and change without departing from the fair meaning of the accompanying claims.

1. A heater module for a heater for a thermal management system for an electric vehicle, the heater module comprising:
a module housing having a module inlet and a module outlet;
a module inlet header that is in fluid communication with the module inlet so as to receive a coolant from the module inlet;
a module outlet header that is in fluid communication with the module outlet so as to transport the coolant to the module outlet;
a plurality of module coolant conduits extending between the module inlet header and the outlet header, wherein there is a PCM storage space defined in the module housing between the module coolant conduits;
a plurality of thermal conductors extending from the plurality of module coolant conduits into the PCM storage space;
a quantity of phase-change material in the PCM storage space and in contact with the plurality of thermal conductors; and
wherein the heater module housing is positioned in engagement with an electric heating element.

2. The heater module as claimed in claim 1, wherein the plurality of thermal conductors are fins in the form of an undulating pattern and are contiguous with one another.

3. The heater module as claimed in claim 1, wherein the thermal conductors have through-holes therethrough, wherein the through-holes extend parallel to the module coolant conduits and wherein the phase-change material is present in the through-holes.

4. The heater module as claimed in claim 1, wherein the thermal conductors are monolithically formed with the module coolant conduits.

5. A heater for a thermal management system for an electric vehicle, comprising:
a heater housing having a heater inlet and a heater outlet;
a plurality of heater modules contained in the heater housing, wherein each of the plurality of heater modules includes:
a module housing having a module inlet and a module outlet;
a module inlet header that is in fluid communication with the module inlet so as to receive a coolant from the module inlet;
a module outlet header that is in fluid communication with the module outlet so as to transport the coolant to the module outlet;
a plurality of module coolant conduits extending between the module inlet header and the outlet header, wherein there is a PCM storage space defined in the module housing between the module coolant conduits;
a plurality of thermal conductors extending from the plurality of module coolant conduits into the PCM storage space; and
a quantity of phase-change material in the PCM storage space and in contact with the plurality of thermal conductors; and
at least one electric heating element, wherein the module housing of each of the plurality of heater modules has at least one of the at least one electric heating element positioned adjacent thereto for transmission of heat into the phase-change material.

6. The heater as claimed in claim 5, wherein the plurality of thermal conductors are fins in the form of an undulating pattern and are contiguous with one another.

7. The heater as claimed in claim 6, wherein the fins have through-holes therethrough, wherein the through-holes extend parallel to the module coolant conduits and wherein the phase-change material is present in the through-holes.

8. The heater as claimed in claim 5, wherein each electric heating element is positioned between two adjacent ones of the heater modules.

9. The heater as claimed in claim 5, wherein the thermal conductors are monolithically formed with the module coolant conduits.

10. A thermal management system for an electric vehicle, the electric vehicle including a traction motor, a traction motor battery, and a charger for use in charging the traction motor battery from an external charge source, the thermal management system comprising:
a vehicle coolant conduit system that contains a coolant;
a pump that is positioned to drive the coolant to flow through the vehicle coolant conduit to draw heat from the charger during operation of the charger;
a heater that includes
a heater housing having a heater inlet and a heater outlet, wherein the heater inlet and the heater outlet are fluidically connected to the vehicle coolant conduit system;
a heater coolant conduit system that fluidically connects the heater inlet and the heater outlet;
wherein there is a PCM storage space defined in the heater housing outside the heater coolant conduit system;
a quantity of phase-change material in the PCM storage space, positioned to undergo heat exchange with the coolant in the heater coolant conduit system; and
at least one electric heating element positioned to heat the phase-change material; and
a controller programmed to operate the charger to charge the traction motor battery when the electric vehicle is connected to an external power source,
wherein the controller is programmed to operate the pump to drive the coolant to flow through the vehicle coolant conduit to draw heat from the charger during operation of the charger, thereby heating the coolant,
wherein, during operation of the charger, the controller is programmed to determine a temperature of the coolant, and to drive coolant flow through the heater in order to heat the phase-change material if the temperature of the coolant is higher than a selected threshold coolant temperature,
and wherein, when the electric vehicle is connected to the external power source, the controller is programmed to operate the at least one electric heating element in order to heat the phase-change material at least some of the time.

11. (canceled)

12. (canceled)
